(19) United States
(12) Patent Application Publication
(10) Pub. No.: US 2008/0052115 A1
(43) Pub. Date: Feb. 28, 2008

(54) Computerized medical information system

(75) Inventors: Matt Spradley, Frisco, TX (US); Steve Strittmatter, Frisco, TX (US); Srikanth Talla, Irving, TX (US); Amirall Rajan, Richardson, TX (US)

Correspondence Address: GORDON & REES LLP, 101 WEST BROADWAY, SUITE 1600, SAN DIEGO, CA, 92101, US

(73) Assignee: Eklin Medical Systems, Inc., Santa Clara, CA (US)

(21) Appl. No.: 11/895,247

(22) Filed: Aug. 23, 2007

Related U.S. Application Data
(60) Provisional application No. 60/839,844, filed on Aug. 24, 2006.

(51) Int. Cl. G06Q 50/00; G06Q 10/00

(52) U.S. Cl. 705/2

(57) ABSTRACT

A system for managing electronic medical records, including: (a) an originator facility, having: data sources storing data segments in different formats; and a data encoder configured to construct a consolidated electronic medical record from the data segments, the data encoder being configured to attach a unique identification tag to the consolidated electronic medical record and to the individual data segments; (b) a data delivery and messaging platform configured to transmit the consolidated electronic medical record and the unique identification tags over the internet; and (c) at least one recipient facility configured to receive the consolidated electronic medical record and the unique identification tags from the data delivery and messaging platform, having: a data decoder configured to extract the consolidated electronic medical record and the unique identification tags; and a plurality of data repositories, each data repository comprising a one or more data segments stored in a different format.

### RELATED APPLICATION

The present application claims priority to U.S. Provisional Patent Application 60/839,844, entitled “Computerized Medical Information System”, filed Aug. 24, 2006, incorporated herein by reference in its entirety for all purposes.

### TECHNICAL FIELD

The present invention is related to computerized systems for transferring medical records and medical record information.

### BACKGROUND OF THE INVENTION

A patient's medical data exists in various medical information systems that may by physically or logically dispersed. For example, medical data may be stored as data segments that exist in different physical locations within one medical facility, or at various facilities around the globe. Additionally, these data segments may be stored differently from one another, e.g.: as text, video, images, DICOM (Digital Imaging and Communications in Medicine), as structured or unstructured data in a file or a database, as custom binary data, etc.

Clearly, there is a need to consolidate and reconcile a patient's medical data existing in various disparate medical information systems in to one single and self-contained electronic medical record (EMR).

Unfortunately, previous attempted solutions to this problem have not truly been successful. For example, one attempted solution is the “Health Level Seven (HL7)” standards developing organization. HL7 provides a system for exchanging patient clinical and administrative messages between different software systems in a hospital's network. Unfortunately, HL7 was not designed for inter hospital communications. It is also very rigid in the types of data that are communicated. Nor does it specify how applications store or process the data. Also, HL7 does not address synchronizing a consolidated medical record.

As such, HL7 does not provide a single application that would consolidate disparate medical records into a single EMR. Moreover, HL7 does not specify transport logistics or architecture involved in transferring messages between systems (either in the same medical facility, or scattered across the globe). Therefore, HL7 does not specify how a consolidated EMR can be built from disparate medical software applications at one single logical application. Because each HL7 message is totally different from another, the data transferred among various applications does not travel as part of one patient's logical EMR nor is there any globally unique identification common across all HL7 messages. As such, HL7 does not specify transport logistics or architecture involved in transferring messages between systems located in either the same medical facility or scattered across the globe.

As such, HL7 does not specify transport logistics or architecture involved in transferring messages between systems located in either the same medical facility or scattered across the globe.

A second existing system is the Bidirectional Health Information Exchange (BHIE). BHIE is a joint information technology data exchange initiative between the Department of Veterans Affairs (VA) and Department of Defense (DoD). BHIE permits VA and DoD clinicians to view electronic healthcare data from each other's systems, VA's Computerized Patient Record System (CPRS) and DoD's Composite Health Care System (CHCS). The data are shared bidirectionally, in real time, for patients who receive care from both VA and DoD facilities. Currently, the data that are made viewable bidirectionally using BHIE are: Outpatient pharmacy data, Allergy data, Patient identification correlation, Laboratory result data including surgical pathology reports, cytology and microbiology data, chemistry and hematology data, Lab orders data and Radiology reports. Unfortunately, BHIE specifically addresses communications between the Dod and the VA. It does not address the medical record in a general sense. It is also more focused on querying data in remote systems versus compiling a consolidated record in multiple locations.

With existing systems, it is currently very difficult to present a fully consolidated view of the patient's medical records, either to a physician, health care provider, or even to the patient him/herself. This is especially true when both data and the individuals accessing the data are in different physical locations.

### SUMMARY OF THE INVENTION

The present invention overcomes the current problems of electronic medical records being stored at different locations and in different formats by providing a system that consolidates electronic medical information from disparate medical information systems, and provides unique identification both to the consolidated EMR and to its data segments.

In preferred embodiments, the present invention provides an internet based communication platform for EMR delivery, distribution and data synchronization among participating medical facilities. As such, a single EMR can easily be transported (e.g.: concurrently) to any number of desired recipient medical information systems. Therefore, the present invention also provides an Internet based communication platform for EMR delivery, distribution and data synchronization among the participating medical facilities.

In preferred embodiments, the present invention provides a system for managing electronic medical records, comprising: (a) an originator facility, comprising: a plurality of data sources, each data source comprising a data segment stored in a different format; and a data encoder configured to construct a consolidated electronic medical record from the data segments stored in the plurality of data sources, the data encoder being configured to attach a unique identification tag to the consolidated electronic medical record and to the individual data segments; (b) a data delivery and messaging platform configured to transmit the consolidated electronic medical record and the unique identification tags of the consolidated electronic medical record and the individual data segments over the internet; and (c) at least one recipient facility configured to receive the consolidated electronic medical record and the unique identification tags of the consolidated electronic medical record and the individual data segments from the data delivery and messaging platform, the at least one recipient facility comprising: a data decoder configured to extract the consolidated electronic medical record and the unique identification tag to the consolidated electronic medical record and to the individual data segments; and a plurality of data repositories, each data repository comprising a data segment stored in a different format.

Data may be stored in the originator facility as images, video, structured or unstructured data in files or databases, DICOM data, and data stored in hospital information systems.

The data delivery and messaging platform is preferably configured to synchronize the consolidated electronic medical record and the unique identification tags of the consolidated electronic medical record and the individual data segments among a plurality of different recipient facilities.

Optionally, the present system also includes an internet-based messaging platform that attaches messages to the consolidated electronic medical record.

In various aspects, the data delivery and messaging platform may be either a “data-push” or a “data-pull” system configured to transmit the consolidated electronic medical record and the unique identification tags to the recipient facility.

The recipient facility is optionally configured to display the consolidated electronic medical record on a computer screen, if desired.

Advantages of the present system include the fact that it may synchronize the transferred EMR with the recipient's medical information system in a seamless manner. Thus, the present invention advantageously gathers medical records from various physically and logically dispersed medical information systems. In addition, the present system may also provide an internet based messaging platform that allows user/system/application messages to be associated to any particular EMR in distribution.

Moreover, the present invention advantageously provides a system in which a single logical EMR is created that is globally unique, extendable, customizable and transportable over the internet. A further advantage of the system is that the EMR is fully extensible so that any medical data from any medical information system can be aggregated in to the EMR. Moreover, each logically different data segments inside the EMR would have an identification which is guaranteed to be unique among all computing platforms in the world. As such, the present single logical EMR operates with a globally unique addressing of individual data segments, giving it the ability to reconcile and merge the clinical data as it travels across the internet to various medical information systems that are geographically dispersed.

In addition, the present invention need not specify the format or content of the messages; however, the present invention may specify how to process and store the data segments.

### BRIEF DESCRIPTION OF THE DRAWINGS

FIG. 1 is a schematic illustration of the present system.

FIG. 2 is a flow diagram showing EMR transmission.

FIG. 3 is an illustration of an embodiment of the invention where a recipient can view the EMR.

FIG. 4 is an illustration of an embodiment of the invention where a recipient can download the EMR.

FIG. 5 is an illustration of an embodiment of the invention similar to FIG. 3, but having a data-push architecture.

FIG. 6 is an illustration of an embodiment of the invention similar to FIG. 5, but further including a two-way internet messaging feature.

### DETAILED DESCRIPTION OF THE DRAWINGS

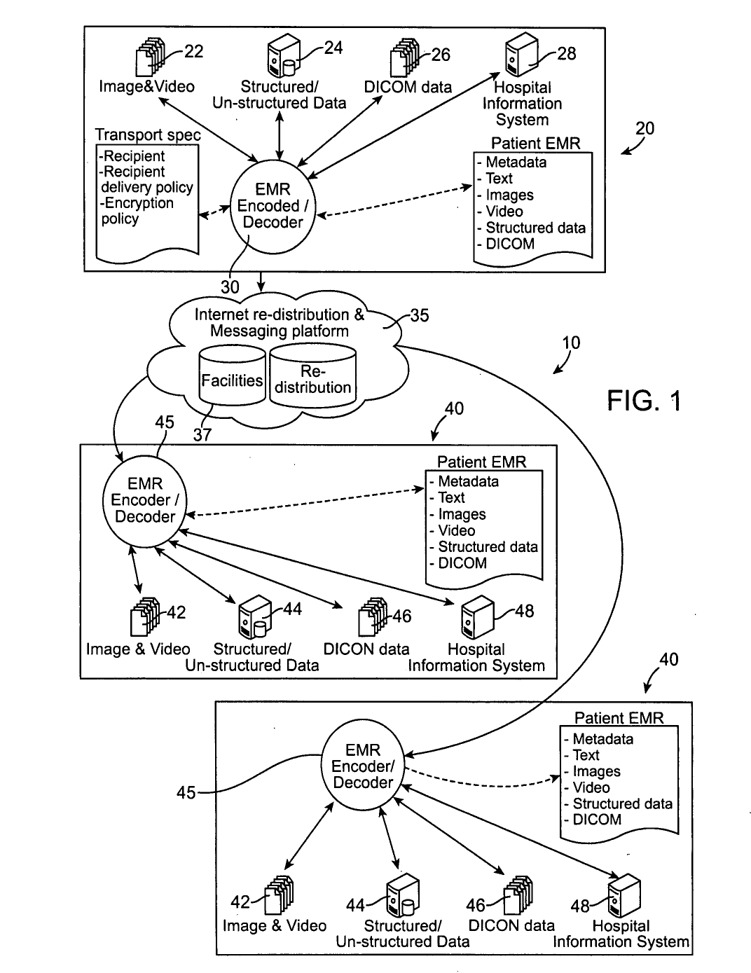

As seen in FIG. 1, system 10 comprises an originator facility 20 and one or more recipient facilities 40.

In accordance with the present invention, originator facility 20 may include one or more sources of data, or data applications, including, but not limited to data stored as images and/or video 22, structured or unstructured data 24 in files/databases, DICOM™ (Digital Imaging and Communication in Medicine) data 26 and data in hospital information system 28. It is to be understood that labelled elements 22, 24, 26 and 28 are merely exemplary, and that the present invention is not limited to any particular system or format of medical data storage. Rather, the present invention consolidates medical records data segments from one or more different sources to produce a single EMR, without being particularly limited to any system or format of medical data storage.

Originator facility 20 comprises an encoder 30. Encoder 30 constructs a single consolidated EMR from the medical data in sources/applications 22, 24, 26 and 28. This is done by breaking the record into segments by data type and further dividing those segments as necessary to facilitate transporting the data over the internet. Each segment has a GUID, timestamp, originator GUID, and is digitally signed to prevent alteration. This information is used to reconstitute the record at the receiving facility. After the single consolidated EMR has been created, encoder 30 attaches a unique identification tag to both: (1) the consolidated EMR, and (2) the individual data segment comprising the consolidated EMR. In a preferred implementation, the tag is generated using Microsofts GUID which is an implementation of the UUID specified by the Open Software Foundation (OSF). However, it is to be understood that any method that generates a unique ID (within a reasonable confidence level) is acceptable. As such, both the full consolidated EMR, and its various components (i.e.: the data segments making up the consolidated EMR) have their own unique identification tags.

Encoder 30 then delivers the data/messages to a data delivery and messaging platform 35 that in turn sends the needed EMR segments to one or more desired recipient facilities 40. Recipient facilities 40 may comprise participating facilities, doctors, individuals, or any combination thereof.

In optional embodiments, platform 35 obtains a participating network list 37 through a webservice. Network list 37 may include a list of participating recipient facilities 40, including various, institutions, doctors and individuals to which the EMRs (and their associated unique identification tags) are sent.

The user at originator facility 20 then has the choice to select the desired recipient facilities 40 to receive the consolidated EMR.

Preferably, data delivery and messaging platform 35 is configured to synchronize the consolidated EMR and its unique identification tags among a plurality of different recipient facilities 40. The recipient facilities can collaborate with the messaging platform to optimize what data segments are to be sent. A recipient facility may already have some of the data segments in its version of the EMR (as identified by the respective unique identifiers). The messaging platform only needs to send the segments that the receiving facility does not have.

Platform 35 may optionally comprise an internet-based messaging platform that attaches messages to the consolidated electronic medical record. For example, the consolidated EMR may contain optional place holders for the user to attach customizable text messages.

Platform 35 may either be a “data-push” or a “data-pull” system that transmits the consolidated EMR and its unique identification tags to the recipient facilities 40. In the case of data-push, a WS-Eventing protocol (as formulated by a consortium of companies such as Microsoft, IBM, BAE Systems, Computer Associates, Sun Micro systems and TIBCO software ) may optionally be used to deliver the EMR automatically and concurrently to all desired recipient facilities 40. In the case of data-pull, a webservice may provide interfaces to each of recipient facilities 40 to poll for data availability. The recipients who are notified of the availably of the EMR download can then initiate download activity.

The downloaded EMR at each recipient facility 40 is processed by an EMR decoder application 45 to extract the various data segments in the consolidated EMR. Through the unique identifier embedded in each data segment, decoder 45 extracts the various data segments. Next, decoder 45 can upload the various data segments to the appropriate medical information systems at recipient facility 40. For example, individual data segments may be uploaded to each of one or more sources of data, or data applications, including, but not limited to, images and/or video 42, structured or unstructured data 44, DICOM™ data 46 and hospital information system data 48. Thus, full data synchronization functionality can be achieved. Moreover, by installing an encoder 30 and a decoder 45 at each facility (i.e.: facilities 20 and 40), a full duplex mode of EMR transfer can be achieved among all facilities 20 and 40.

Preferably, recipient facility 40 is configured to display the consolidated electronic medical record on a computer screen, for viewing by a physician, veterinarian, health professional or patient. The present invention is not so limited. For example, recipient facilities 40 may simply store data received from platform 35 in desired formats and systems.

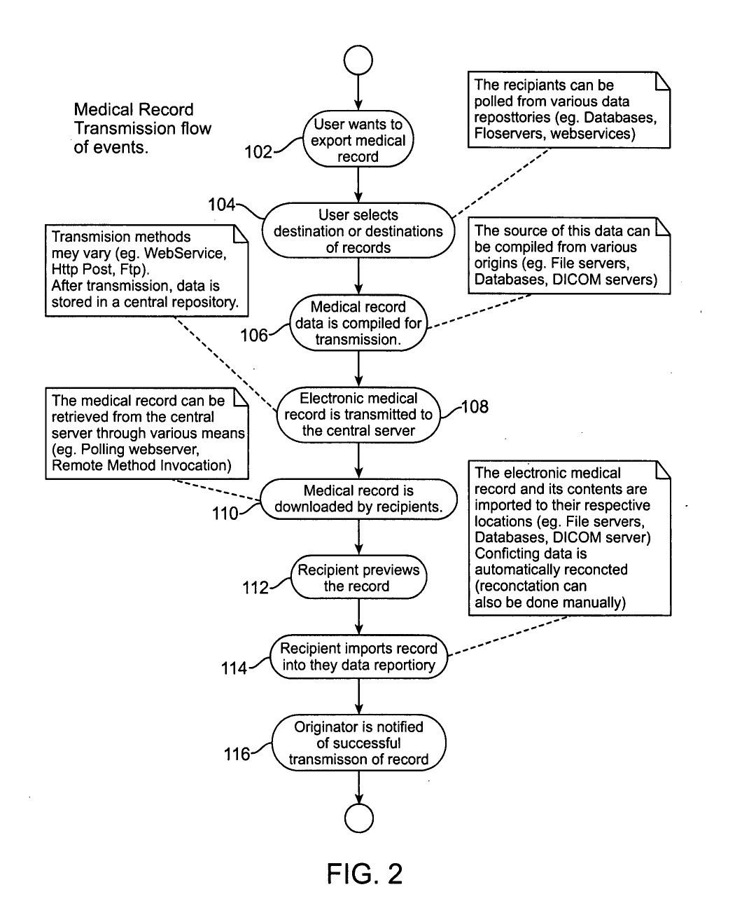

FIG. 2 illustrates a sequence of events in the transmission of an EMR, as follows. At step 102, a user at originator facility 20 selects an EMR for export. Encoder 30 generates this EMR from data sources 22 to 28, and assigns a unique identification tag to the consolidated EMR and to its various data segments, as outlined above.

Next, at step 104, the user at originator facility 20 selects a destination (i.e.: one or more recipient facilities 40). The selection of recipient facilities 40 may optionally be done by accessing, and reviewing, participating network list 37. Preferably, participating network list 37 is uploaded to platform 35 together with the EMR itself.

Next, at step 106, encoder 30 prepares the EMR for transmission. Next, at step 108, the EMR is transmitted by platform 35 to one or more recipient facilities 40. This transmission may optionally be done by a webservice, an http posting, or a file transfer protocol (FTP).

Next, at step 110, the EMR is downloaded by a user at recipient facility 40. This may be accomplished by various methods including a polling webserver, or remote method invocation. Specifically, the downloaded EMR at each recipient's facility 40 is processed by the EMR decoder application 45 which decodes and extracts various data segments present in the consolidated EMR. Through the unique identification embedded with in each data segment of EMR, decoder application 45 identifies and uploads each data segment to the appropriate medical information system (42 to 48) at recipient facility 40, thus achieving full data synchronization functionality. By installing both EMR encoder 30 and decoder 45 applications at all participating facilities 20 and 40 in the network, a full duplex mode of EMR transfer can be achieved among all facilities.

In the process of EMR decoding, the user may optionally preview the EMR data at step 112. Next, the user in recipient facility 40 may import the data in the EMR into the data repositories 42 to 48, in a manner as desired. At this step as well, conflicting data may be reconciled, either manually or automatically.

Lastly, at step 116, as part of the optional two-way communication feature of the invention, the user in originator facility 20 may be notified of the successful transmission of the EMR from originator facility 20 to recipient facility 40.

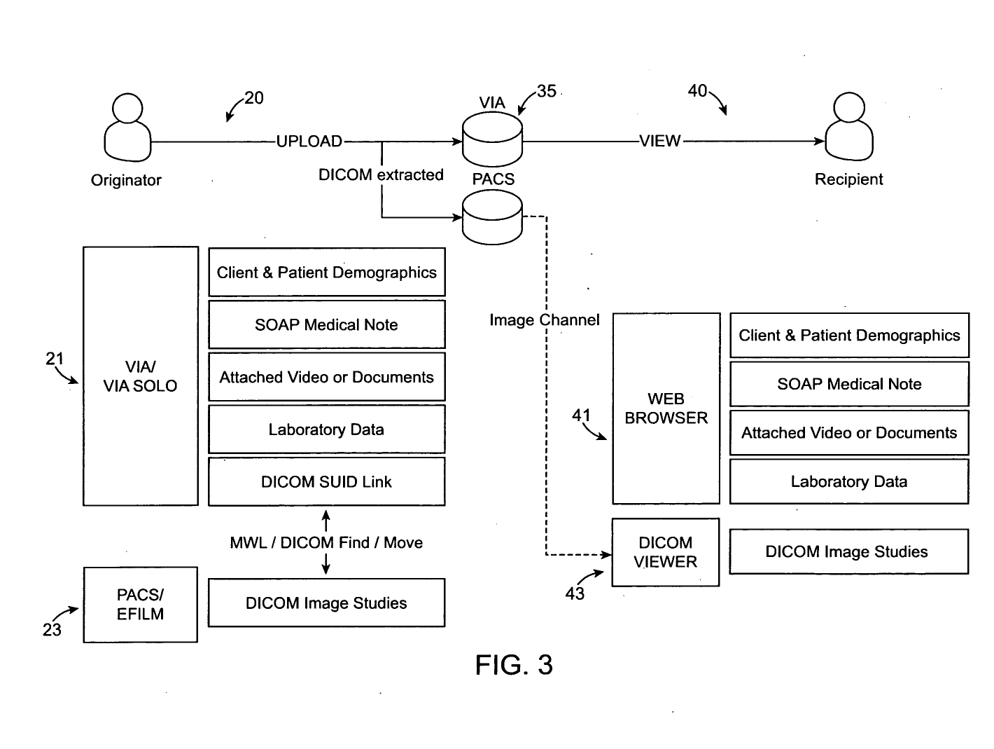

FIG. 3 is an illustration of an embodiment of the invention where a recipient can view the EMR. Specifically, an originator in facility 20 uploads data to a data center having platform 35. This may be done with the originator using VIA™ or VIA SOLO™ software 21 (made by Elinc Corporation, of Frisco, Tex.) for storing the data, including patient identifiers, records, etc., and a Picture Archiving and Communication System (PACS) 23 to store radiographic images of the patient. In this embodiment of the invention, the recipient in facility 40 may use a web browser 41 to retrieve the data, and a DICOM™ viewer 43 to view the radiographic images.

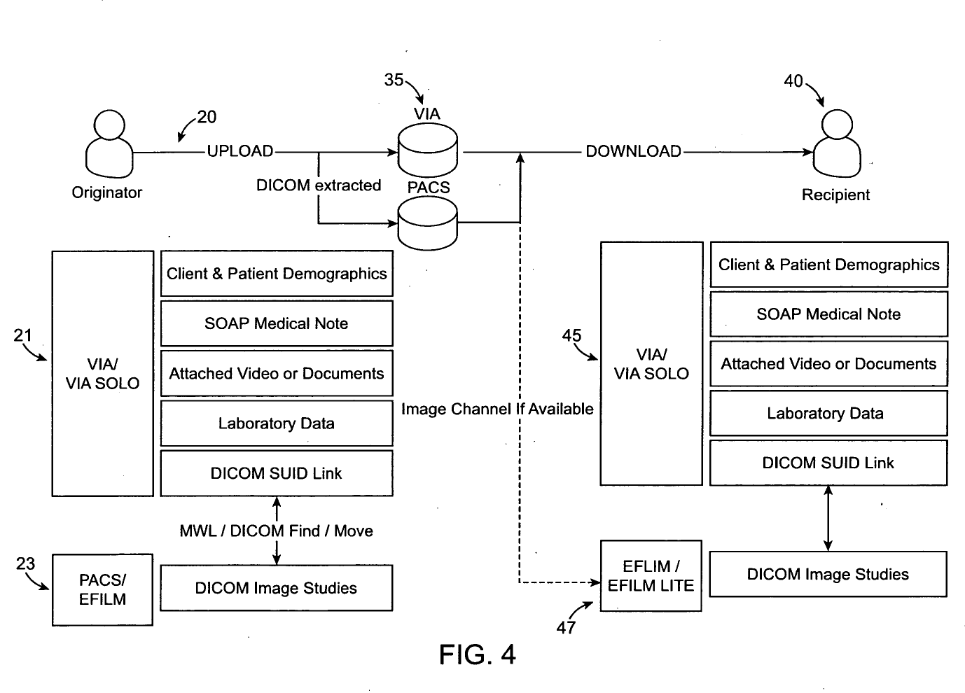

FIG. 4 is an illustration of an embodiment of the invention where a recipient can download the EMR. FIG. 4 is similar to FIG. 3, however, the user in recipient facility 40 instead also uses using VIA™ or VIA SOLO™ software 41 (which is identical to software platform 21); and an EFILM™ or EFILM LIT™ viewing software 47.

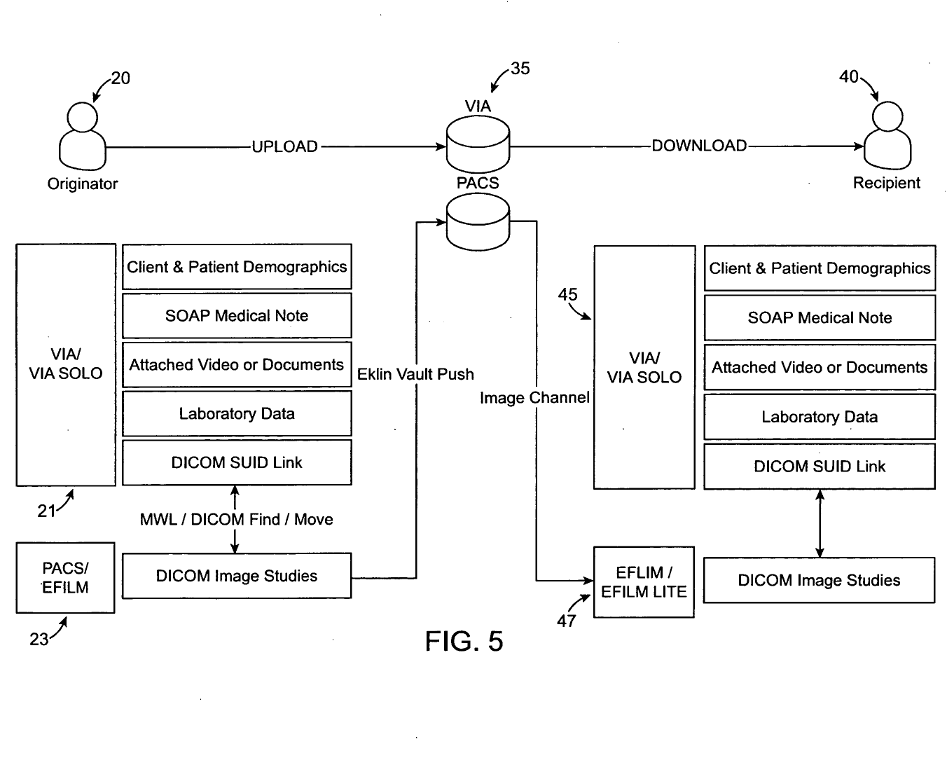

FIG. 5 is an illustration of an embodiment of the invention similar to FIG. 3, but images are maintained on a central PACS server. The metadata necessary to query the PACS and retrieve the images are all that is included in the EMR transfer. This approach would minimize the amount a bandwidth and redundant storage. This approach might be used when facilities are within the same organization or tightly linked in some other way.

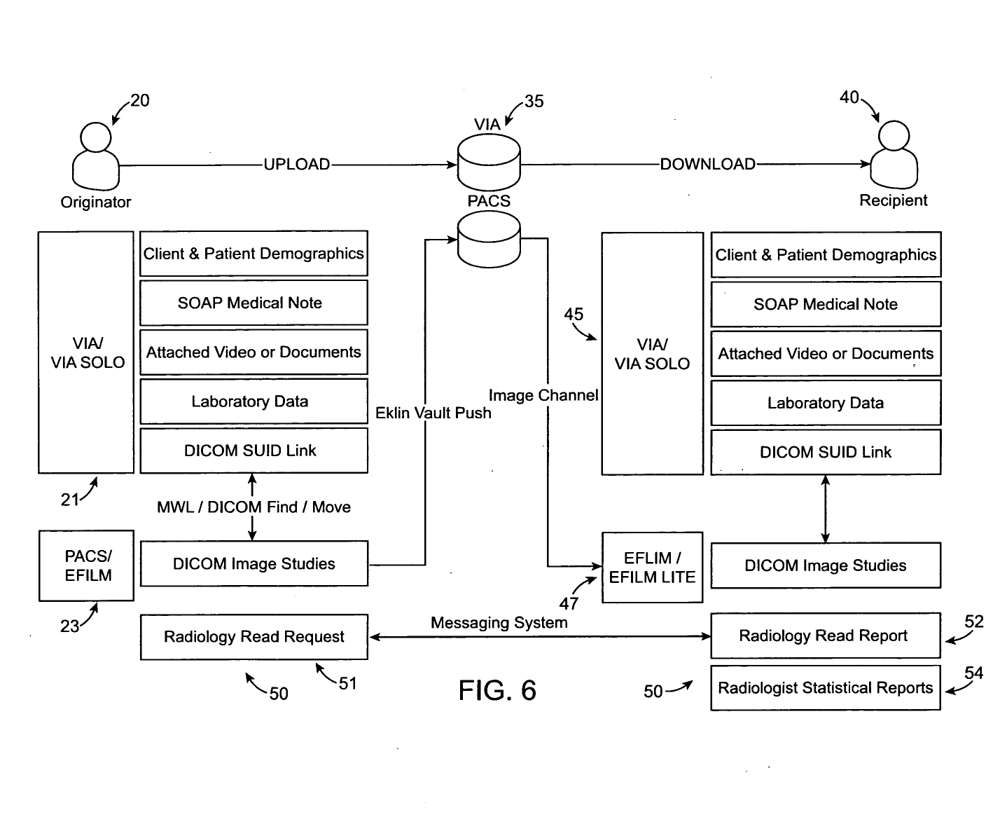

Lastly, FIG. 6 is an illustration of an embodiment of the invention similar to FIG. 5, but further including a two-way internet messaging system 50. Messaging system 50 may optionally include a read request 51 (for use in originating facility 20) and both a read report 52 and statistical report 54 (for use in receiving facility 20).

What is claimed:

1. A system for managing electronic medical records, comprising:
(a) an originator facility, comprising:
a plurality of data sources, each data source comprising one or more data segments stored in a different format; and
a data encoder configured to construct a consolidated electronic medical record from the data segments stored in the plurality of data sources, the data encoder being configured to attach a unique identification tag to the consolidated electronic medical record and to the individual data segments;
(b) a data delivery and messaging platform configured to transmit the consolidated electronic medical record and the unique identification tags of the consolidated electronic medical record and the individual data segments over the internet; and
(c) at least one recipient facility configured to receive the consolidated electronic medical record and the unique identification tags of the consolidated electronic medical record and the individual data segments from the data delivery and messaging platform, the at least one recipient facility comprising:
a data decoder configured to extract the consolidated electronic medical record and the unique identification tag to the consolidated electronic medical record and to the individual data segments; and
a plurality of data repositories, each data repository comprising a data segment stored in a different format.

2. The system of claim 1, wherein the plurality of data sources comprise data stored as images, video, structured or unstructured data in files or databases, DICOM data, and data stored in hospital information systems.

3. The system of claim 1, wherein the at least one recipient facility comprises a plurality of recipient facilities.

4. The system of claim 1, wherein the data delivery and messaging platform is configured to synchronize the consolidated electronic medical record and the unique identification tags of the consolidated electronic medical record and the individual data segments among a plurality of different recipient facilities.

5. The system of claim 1, further comprising:
an internet-based messaging platform that attaches messages to the consolidated electronic medical record.

6. The system of claim 1, wherein the data delivery and messaging platform comprises a network list of a plurality of recipient facilities.

7. The system of claim 1, wherein the data delivery and messaging platform is a data-push system configured to transmit the consolidated electronic medical record and the unique identification tags to the at least one recipient facility.

8. The system of claim 1, wherein the data delivery and messaging platform is a data-pull system configured to transmit the consolidated electronic medical record and the unique identification tags to the at least one recipient facility.

9. The system of claim 1, wherein the at least one recipient facility is configured to display the consolidated electronic medical record on a computer screen.
